(19) United States
(12) Patent Application Publication
(10) Pub. No.: US 2025/0079989 A1
(43) Pub. Date: Mar. 6, 2025

(54) POWER SEMICONDUCTOR DEVICE AND BOOST CONVERTER

(71) Applicant: ROHM CO., LTD., Kyoto (JP)

(72) Inventor: Tadashi AKAHO, Kyoto (JP)

(21) Appl. No.: 18/951,789

(22) Filed: Nov. 19, 2024

Related U.S. Application Data
(63) Continuation of application No. PCT/JP2023/006174, filed on Feb. 21, 2023.

(30) Foreign Application Priority Data
May 27, 2022 (JP) 2022-086737

(51) Int. Cl. H02M 3/158

(52) U.S. Cl. CPC H02M 3/158

(57) ABSTRACT

A power semiconductor device used in a boost converter to boost an input voltage comprises: an output terminal; a switching circuit including a switching transistor and configured to generate an output terminal voltage at the output terminal using an inductor that receives the input voltage, the output terminal voltage resulting from boosting of the input voltage; a feedback terminal to receive a monitoring subject voltage responsive to the output terminal voltage via an external wire of the power semiconductor device; and a control driving circuit configured to control the switching circuit on the basis of error between a comparison voltage and a predetermined reference voltage, the comparison voltage being determined on the basis of a feedback voltage applied to the feedback terminal and the output terminal voltage.

### CROSS-REFERENCE TO RELATED APPLICATIONS

This nonprovisional application is a continuation application of International Patent Application No. PCT/JP2023/006174 filed on Feb. 21, 2023, which claims priority to Japanese Patent Application No. 2022-086737 filed on May 27, 2022, the entire contents of which are hereby incorporated by reference.

### TECHNICAL FIELD

The present disclosure relates to a power semiconductor device and a boost converter.

### BACKGROUND

A boost converter to boost an input voltage monitors a boosted voltage as a monitoring subject, and is provided with a feedback terminal to receive feedback of the boosted voltage. Switching control is performed on the basis of the feedback voltage applied to the feedback terminal, thereby allowing the boosted voltage to be stabilized at an intended target voltage.

### CITATION LIST

### Patent Document

Patent Document 1: Japanese Patent Application Publication No. 2019-221099

### BRIEF DESCRIPTION OF THE DRAWINGS

FIG. 1 is an entire configuration view of a boost converter according to an embodiment of the present disclosure;

FIG. 2 is an outline perspective view of a power supply IC according to the embodiment of the present disclosure;

FIG. 3 is a view showing a state (open failure state) where a break occurs in a feedback wire in the boost converter according to the embodiment of the present disclosure;

FIG. 4 is an entire configuration view of a boost converter according to a first practical example belonging to the embodiment of the present disclosure;

FIG. 5 is a view showing the boost converter in a normally-connected state according to the first practical example belonging to the embodiment of the present disclosure;

FIG. 6 is a view showing the boost converter in the open failure state according to the first practical example belonging to the embodiment of the present disclosure;

FIG. 7 is an entire configuration view of a boost converter according to n second practical example belonging to the embodiment of the present disclosure;

FIG. 8 is a view showing the boost converter in the normally-connected state according to the second practical example belonging to the embodiment of the present disclosure; and

FIG. 9 is a view showing the boost converter in the open failure state according to the second practical example belonging to the embodiment of the present disclosure.

### DETAILED DESCRIPTION

Examples of an embodiment of the present disclosure will now be specifically described with reference to the drawings. Corresponding parts in the drawings to be referred to are given the same sign and description of these parts overlapping therebetween will basically be omitted. In the present description, in order to simplify statement, information, signals, physical quantities, functional units, circuits, elements, or parts may be referred to with symbols or signs to omit or abbreviate the names of such information, signals, physical quantities, functional units, circuits, elements, or parts corresponding to these symbols or signs.

First, some terms used in the statement of the embodiment of the present disclosure will be explained. An IC is an abbreviation for an integrated circuit. A ground denotes a reference conductive part having a potential of 0 V (zero volts) as a reference or denotes a potential of 0 V itself. The reference conductive part may be formed using a conductor such as metal. A potential of 0 V may be called a ground potential. In the embodiment of the present disclosure, a voltage shown without particular reference represents a potential with respect to the ground.

A level denotes a potential level. Regarding an arbitrary signal or an arbitrary voltage of focus, a high level has a higher potential than a low level. Regarding an arbitrary signal or an arbitrary voltage of focus, the signal or the voltage at the high level means that the level of the signal or the voltage is high in a strict sense, and the signal or the voltage at the low level means that the level of the signal or the voltage is low in a strict sense. The level regarding the signal may be expressed as a signal level. The level regarding the voltage may be expressed as a voltage level.

Regarding an arbitrary transistor configured as an FET (field-effect transistor) including a MOSFET, an on state denotes a state where a drain and a source of the transistor are electrically connected to each other, and an off state denotes a state (cut-off state) where the drain and the source of the transistor are not electrically connected to each other. This also applies to a transistor not categorized as an FET. The MOSFET is understood as an enhancement MOSFET unless otherwise specified. The MOSFET is an abbreviation for a “metal-oxide-semiconductor field-effect transistor.” It can be considered that, in an arbitrary MOSFET, a back gate is short-circuited to a source unless otherwise specified.

Electrical characteristics of a MOSFET include a gate threshold voltage. In an arbitrary transistor that is an N-channel enhancement MOSFET, if a gate potential of the transistor is higher than a source potential of the same transistor and if a gate-to-source voltage (the gate potential with respect to the source potential) of the transistor is equal to or greater in magnitude than a gate threshold voltage of the same transistor, the transistor is in the on state. If not, the transistor is in the off state. In an arbitrary transistor that is a P-channel enhancement MOSFET, if a gate potential of the transistor is lower than a source potential of the same transistor and if a gate-to-source voltage (the gate potential with respect to the source potential) of the transistor is equal to or greater in magnitude than a gate threshold voltage of the same transistor, the transistor is in the on state. If not, the transistor is in the off state. A gate threshold voltage in an arbitrary FET is defined as a gate-to-source voltage necessary for causing a drain current of a predetermined magnitude to flow in a predetermined ambient temperature environment while a predetermined voltage is applied between a drain and a source of the FET.

An arbitrary switch element can be configured using one or more FETs (field-effect transistors). If one switch element is in the on state, a conducting state is formed across the switch element. If one switch element is in the off state, a non-conducting state is formed across the switch element.

In the following, the on state and the off state regarding an arbitrary transistor or an arbitrary switch element may simply be expressed as on and off respectively. Regarding an arbitrary transistor or an arbitrary switch element, switch from the off state to the on state may be expressed as turn-on, and switch from the on state to the off state will be expressed as turn-off. Regarding an arbitrary transistor or an arbitrary switch element, a period when the transistor or the switch element is in the on state may be called an on period, and a period when the transistor or the switch element is in the off state may be called an off period.

It can be understood that connection between a plurality of sections forming a circuit including an arbitrary circuit element, an arbitrary wire (line), an arbitrary node, etc. is electrical connection unless otherwise specified.

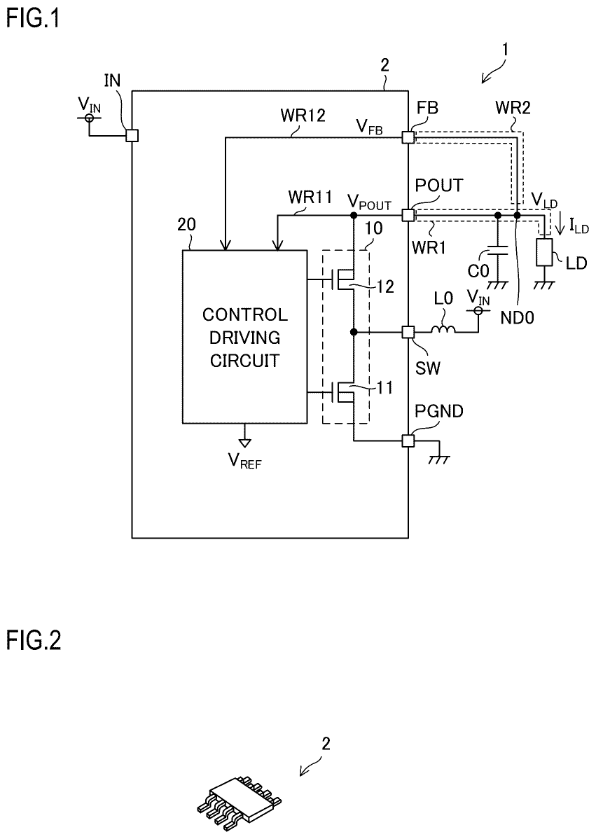

FIG. 1 is an entire configuration view of a boost converter 1 according to an embodiment of the present disclosure. The boost converter 1 in FIG. 1 includes a power supply IC 2 as a power semiconductor device, and a plurality of discrete parts externally connected to the power supply IC 2. The plurality of discrete parts provided at the boost converter 1 includes an inductor L0 and an output capacitor C0. The boost converter 1 is a boosting switching power supply device (DC/DC converter) that receives an input voltage V_{IN} supplied from the outside, and generates a voltage resulting from boosting the input voltage V_{IN}.

FIG. 2 shows an outline perspective view of the power supply IC 2. The power supply IC 2 is an electronic component including a semiconductor chip with a semiconductor integrated circuit formed on a semiconductor substrate, a housing (package) accommodating the semiconductor chip, and a plurality of external terminals exposed from the housing to the outside of the power supply IC 2. The power supply IC 2 is formed by encapsulating the semiconductor chip into the housing (package) made of resin. The number of the external terminals of the power supply IC 2 and the type of the housing of the power supply IC 2 shown in FIG. 2 are not limited to the illustrated examples but can be designed freely.

In FIG. 1, only an input terminal IN, an output terminal POUT, a switch terminal SW, a ground terminal PGND, and a feedback terminal FB are shown as some of the plurality of external terminals provided at the power supply IC 2. Meanwhile, other terminals (an enable terminal or a power-good terminal, for example) are also provided at the power supply IC 2. The boost converter 1 is provided with wires including a wire that is provided external to the power supply IC 2 and is particularly called an external wire, and a wire that is provided inside the power supply IC 2 and is particularly called an internal wire.

The input voltage V_{IN} is supplied from a voltage source not shown in the drawings to the input terminal IN. The input voltage V_{IN} is a positive direct-current voltage. One end of the inductor L0 is connected to an application terminal for the input voltage V_{IN} to receive the input voltage V_{IN}. The one end of the inductor L0 can be understood as being connected to the input terminal IN. The other end of the inductor L0 is connected to the switch terminal SW. The ground terminal PGND is connected to the ground.

The boost converter 1 is provided with an output wire WR1 as an external wire connected to the output terminal POUT. One end of the output wire WR1 is connected to the output terminal POUT. The other end of the output wire WR1 is connected to a load LD. A voltage applied to the output terminal POUT is called an output terminal voltage V_{POUT}. A voltage responsive to the output terminal voltage V_{POUT} is supplied as a load voltage V_{LD} to the load LD. The load LD is one or more arbitrary loads to be driven on the basis of the load voltage VID. A current supplied via the output wire WR1 to the load LD is called a load current I_{LD}. The load current I_{LD} flows from the output terminal POUT toward the load LD. One end of the output capacitor C0 is connected to the output wire WR1. The other end of the output capacitor C0 is connected to the ground.

The boost converter 1 is provided with a feedback wire WR2 as an external wire connected to the feedback terminal FB. One end of the feedback wire WR2 is connected to the feedback terminal FB. The other end of the feedback wire WR2 is connected to a node ND0. The node ND0 is a node on the output wire WR1 and is provided at a position along the output wire WR1 as close as possible to load LD. A distance between the node ND0 and the load LD is shorter than at least a distance between the node ND0 and the output terminal POUT. In the following, the load voltage V_{LD} will be considered to be a voltage at the node ND0. The load voltage V_{LD} corresponds to a subject voltage to be monitored at the power supply IC 2 (monitoring subject voltage). A voltage applied to the feedback terminal FB is called a feedback voltage V_{FB}.

The output terminal voltage V_{POUT} is a boosted voltage generated by boosting the input voltage V_{IN}, and is higher than the input voltage V_{IN} accordingly. The load voltage VID is also a boosted voltage generated by boosting the input voltage V_{IN}, and is higher than the input voltage V_{IN} accordingly. If the load current I_{LD} is zero, the load voltage V_{LD} has a value equal to the value of the output terminal voltage V_{POUT}. If the load current I_{LD} is not zero, voltage drop responsive to a wire resistance at the output wire WR1 and the load current I_{LD} is generated between the output terminal POUT and the node ND0. This makes the load voltage V_{LD} lower by this voltage drop than the output terminal voltage V_{POUT}. A voltage representing this voltage drop is expressed as “ΔV.” Thus, “V_{LD})=V_{POUT}−ΔV.” The load current I_{LD} does not flow through the feedback wire WR2.

The power supply IC 2 is provided with a switching circuit 10 and a control driving circuit 20. The switching circuit 10 includes a switching transistor 11 and a rectifier element 12. Here, a synchronous rectifier transistor is used as the rectifier element 12. More specifically, in the switching circuit 10, the switching transistor 11 is composed of an N-channel MOSFET and the synchronous rectifier transistor 12 is composed of a P-channel MOSFET. A source of the synchronous rectifier transistor 12 is connected to the output terminal POUT. A drain of the synchronous rectifier transistor 12 and a drain of the switching transistor 11 are commonly connected to the switch terminal SW. A source of the switching transistor 11 is connected to the ground terminal PGND (and is connected to the ground via the ground terminal PGND accordingly).

The power supply IC 2 is provided with an internal wire WR11 connected to the output terminal POUT and an internal wire WR12 connected to the feedback terminal FB. The output terminal voltage V_{POUT} is applied to the internal wire WR11. The feedback voltage V_{FB} is applied to the internal wire WR12.

The control driving circuit 20 is driven on the basis of an internal power supply voltage. The internal power supply voltage is generated from the input voltage V_{IN} by an internal power supply circuit (not shown in the drawings) provided in the power supply IC 2. The control driving circuit 20 is connected to the output terminal POUT via the internal wire WR11 and is connected to the feedback terminal FB via the internal wire WR12. Thus, the feedback voltage V_{FB} at the feedback terminal FB is input to the control driving circuit 20 and the output terminal voltage V_{POUT} at the output terminal POUT is input to the control driving circuit 20. A predetermined reference voltage V_{REF} is also input to the control driving circuit 20. The reference voltage V_{REF} is generated on the basis of the input voltage V_{IN} by a reference voltage generation circuit (not shown in the drawings) provided in the power supply IC 2. The reference voltage V_{REF} has a predetermined positive direct-current voltage value.

The control driving circuit 20 generates a comparison voltage on the basis of the feedback voltage V_{FB} in general. Then, the control driving circuit 20 performs switching control over the switching circuit 10 in such a manner as to reduce error between the comparison voltage and the reference voltage V_{REF} (to converge the error to zero). The comparison voltage generated on the basis of the feedback voltage V_{FB} is a divided voltage of the feedback voltage V_{FB}. Thus, when the comparison voltage is generated on the basis of the feedback voltage V_{FB}, the load voltage V_{LD} is stabilized at a target voltage V_{TG} (not shown in the drawings) that is determined by a voltage dividing ratio for generating the comparison voltage from the feedback voltage V_{FB} and by the reference voltage V_{REF}.

The control driving circuit 20 is connected to respective gates of the switching transistor 11 and the synchronous rectifier transistor 12 and controls a gate potential at each of the switching transistor 11 and the synchronous rectifier transistor 12, thereby controlling the state of each of the switching transistor 11 and the synchronous rectifier transistor 12. The control driving circuit 20 makes the switching transistor 11 and the synchronous rectifier transistor 12 on and off alternately under the above-described switching control. While the switching transistor 11 is in the on period, the synchronous rectifier transistor 12 is controlled off. While the synchronous rectifier transistor 12 is in the on period, the switching transistor 11 is controlled off. A period when both the switching transistor 11 and the synchronous rectifier transistor 12 are off (dead time) may be interposed between the on period of one transistor of the switching transistor 11 and the synchronous rectifier transistor 12 and the on period of the other transistor.

While the switching transistor 11 is in the on period, a current flows from the application terminal for the input voltage V_{IN} into the ground via the inductor L0, the switch terminal SW, and a channel of the switching transistor 11, thereby accumulating energy in the inductor L0. In a subsequent period when the switching transistor 11 is off and the synchronous rectifier transistor 12 is on, a current based on the energy accumulated in the inductor L0 is supplied from the application terminal for the input voltage V_{IN} into the output capacitor C0 and the load LD via the inductor L0, the switch terminal SW, a channel of the synchronous rectifier transistor 12, and the output terminal POUT.

The control driving circuit 20 may perform switching control using PWM. The PWM is an abbreviation for pulse width modulation. Under the switching control using the PWM, the switching transistor 11 and the synchronous rectifier transistor 12 are made on and off alternately at a predetermined PWM frequency and an on-duty of the switching transistor 11 is adjusted on the basis of the comparison voltage and the reference voltage V_{REF}. The on-duty of the switching transistor 11 denotes the ratio of the length of a period when the switching transistor 11 accounting for one PWM period is on in each PWM cycle. Under the switching control using the PWM, as the on-duty of the switching transistor 11 becomes greater from zero toward a prescribed maximum duty, the quantity of energy (the quantity of energy per unit time) transmitted from the application terminal for the input voltage V_{IN} to the output capacitor C0 and the load LD becomes larger. As a result, the output terminal voltage V_{POUT} and the load voltage V_{LD} increase.

In another case, the control driving circuit 20 may perform switching control using PFM. The PFM is an abbreviation for pulse frequency modulation. Under the switching control using the PFM, the switching transistor 11 and the synchronous rectifier transistor 12 are made on and off alternately at a variable switching frequency and a switching frequency is adjusted on the basis of the comparison voltage and the reference voltage V_{REF}. Under the switching control using the PFM, one on duration of the switching transistor 11 (the length of the on period) is constant. Specifically, under the switching control using the PFM, unit operation is repeated by which the switching transistor 11 is made on and the synchronous rectifier transistor 12 is made off only for a fixed period of time and then the switching transistor 11 is kept off and the synchronous rectifier transistor 12 is kept on. A repetition frequency of the unit operation is adjusted on the basis of the comparison voltage and the reference voltage V_{REF}. As the repetition frequency of the unit operation (namely, a switching frequency of the switching control using the PFM) becomes higher, the quantity of energy (the quantity of energy per unit time) transmitted from the application terminal for the input voltage V_{IN} to the output capacitor C0 and the load LD becomes larger. As a result, the output terminal voltage V_{POUT} and the load voltage V_{LD} increase.

A state where the node ND0 is connected normally to the feedback terminal FB via the feedback wire WR2 is called a normally-connected state. The normally-connected state is a state where the load voltage V_{LD} (namely, a monitoring subject voltage) as a voltage responsive to the output terminal voltage V_{POUT} is applied to the feedback terminal FB via the feedback wire WR2. FIG. 1 shows the boost converter 1 in the normally-connected state. A current flowing in the feedback wire WR2 in the normally-connected state is tiny, and the feedback voltage V_{FB} can be considered to be equal to the load voltage VID.

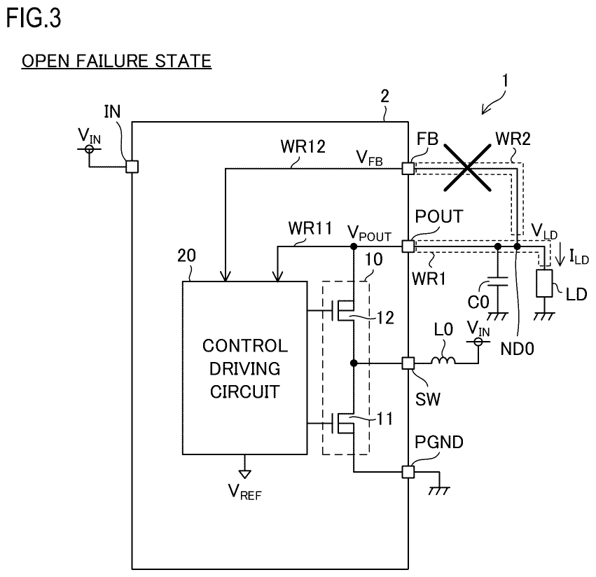

On the occurrence of abnormality at the feedback wire WR2 or poor connection between the feedback wire WR2 and the feedback terminal FB, the load voltage V_{LD} is not transmitted properly to the feedback terminal FB. A typical example of the abnormality at the feedback wire WR2 is a break in the feedback wire WR2. Abnormality caused by the abnormality at the feedback wire WR2 or by the poor connection between the feedback wire WR2 and the feedback terminal FB and bringing the feedback terminal FB into an open state is called an open failure state (see FIG. 3). It is possible that, depending on the state of the feedback wire WR2 or the like, connection between the feedback terminal FB and the node ND0 will become equivalent to connection via a resistive component of about a few hundred kilohms, for example. Meanwhile, in the open failure state mentioned herein, the feedback terminal FB and the node ND0 are insulated from each other via a sufficiently high insulating resistance. A state where transmission of the load voltage V_{LD} (namely, monitoring subject voltage) to the feedback terminal FB is interrupted belongs to the open failure state.

In the open failure state, supposing that switching control is performed on the basis of a voltage applied to the feedback terminal FB (feedback voltage V_{FB}) like in the normally-connected state, the on-duty of the switching transistor 11 under the switching control using the PWM is increased or a switching frequency is increased under the switching control using the PFM independently of the load voltage V_{LD}. This might cause excessive voltage boost (namely, the output terminal voltage V_{POUT} and the load voltage V_{LD} might become excessive voltages). The excessive voltage boost might damage a part (synchronous rectifier transistor 12 or load LD, for example) connected to the output wire WR1. A technique for suppressing such excessive voltage boost is incorporated in the control driving circuit 20.

In a plurality of practical examples given below, some specific exemplary configurations, exemplary operations, applied techniques, modified techniques, etc. relating to the boost converter 1 (in particular, control driving circuit 20) will be described. The foregoing issues of the present embodiment are applied to each of the following practical examples unless otherwise specified or unless there is any inconsistency. If each of the practical examples contains an issue inconsistent to the foregoing issues, priority can be given to the statement in each of the practical examples. Of the plurality of practical examples given below, an issue described in any one of the practical examples can be applied to a different one of the practical examples (specifically, any two or more of the plurality of practical examples can be combined) unless there is any inconsistency.

### First Practical Example

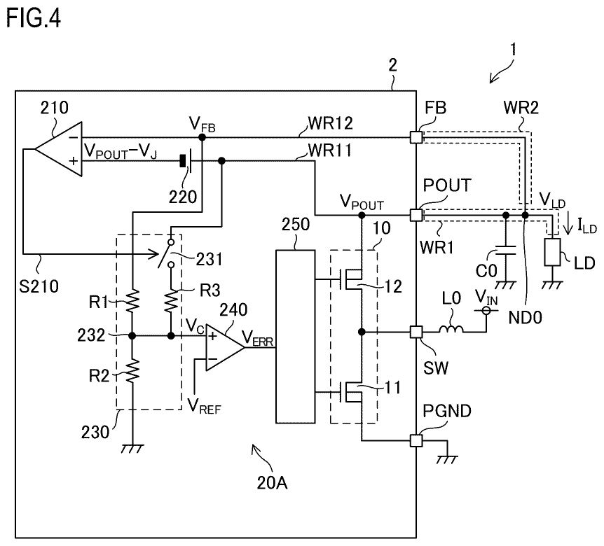

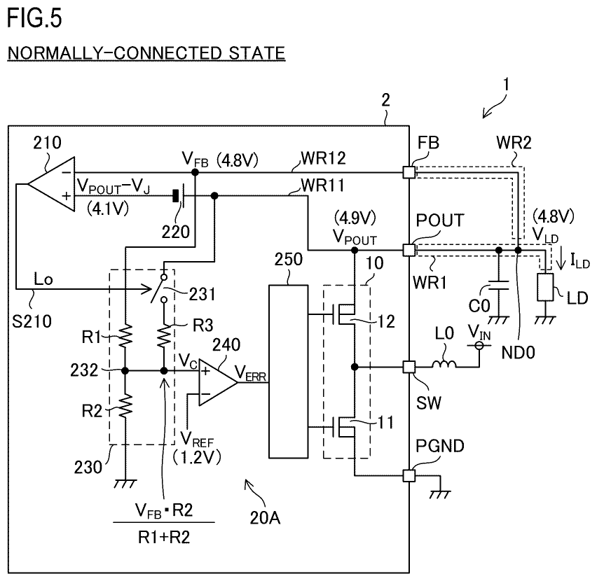

A first practical example will be described. FIG. 4 shows the configuration of a boost converter 1 according to the first practical example. The boost converter 1 according to the first practical example includes a control driving circuit 20A as the control driving circuit 20. The configuration of the control driving circuit 20A will be described.

The control driving circuit 20A includes a comparator 210, a voltage source 220, a comparison voltage generation circuit 230, an error amplifier 240, and a circuit 250 with a logic circuit and a driving circuit.

The comparator 210 has an inverting input terminal, a non-inverting input terminal, and an output terminal. The voltage source 220 generates and outputs a predetermined judging voltage V_{J}. The judging voltage V_{J} has a predetermined positive direct-current voltage value (0.8 V, for example). The voltage source 220 is interposed between the non-inverting input terminal of the comparator 210 and the output terminal POUT. In doing so, a positive-side output end of the voltage source 220 is connected to the internal wire WR11. Thus, the voltage source 220 supplies the non-inverting input terminal of the comparator 210 with a voltage (V_{POUT}−V_{J}), which is a voltage lower than the output terminal voltage V_{POUT} by the judging voltage V_{J}. The inverting input terminal of the comparator 210 is connected via the internal wire WR12 to the feedback terminal FB and receives a voltage (namely, feedback voltage V_{FB}) applied to the feedback terminal FB. The comparator 210 compares the voltage (V_{POUT}−V_{J}) lower than the output terminal voltage V_{POUT} by the judging voltage V_{J} with the feedback voltage V_{FB}, and outputs a signal S210 representing result of the comparison from the output terminal of the comparator 210 itself. If the voltage (V_{POUT}-V_{J}) is higher than the feedback voltage V_{FB}, the comparator 210 outputs the signal S210 at the high level. If the voltage (V_{POUT}−V_{J}) is lower than the feedback voltage V_{FB}, the comparator 210 outputs the signal S210 at the low level. The signal S210 is at the high level or at the low level if “V_{POUT}−V_{J}=V_{FB}” is established.

The comparison voltage generation circuit 230 includes resistors R1 to R3 and a switch element 231, and generates a comparison voltage V_{C} on the basis of the feedback voltage V_{FB} and the output terminal voltage V_{POUT}. One end of the resistor R1 is connected to the feedback terminal FB via the internal wire WR12 and receives a voltage (namely, feedback voltage V_{FB}) applied to the feedback terminal FB. The other end of the resistor R1 is connected to a node 232. One end of the resistor R2 is connected to the node 232. The other end of the resistor R2 is connected to the ground. The resistor R1 and the resistor R2 form a voltage dividing circuit that divides the feedback voltage V_{FB}. One end of the switch element 231 is connected to the output terminal POUT via the internal wire WR11 and receives the output terminal voltage V_{POUT}. The other end of the switch element 231 is connected to one end of the resistor R3. The other end of the resistor R3 is connected to the node 232. The above-described target voltage V_{TG} is determined using a voltage dividing ratio defined by the resistors R1 and R2 and the reference voltage V_{REF}. In formulas given below, the resistance values of the resistors R1, R2, and R3 will be expressed as “R1,” “R2,” and “R3” respectively.

The comparison voltage V_{C} is generated at the node 232. The switch element 231 is controlled on or off on the basis of the output signal S210 from the comparator 210. The switch element 231 is controlled off if the signal S210 is at the low level, and is controlled on if the signal S210 is at the high level.

The error amplifier 240 has an inverting input terminal, a non-inverting input terminal, and an output terminal. The non-inverting input terminal of the error amplifier 240 is connected to the node 232 and receives the comparison voltage V_{C}. The reference voltage V_{REF} is supplied to the inverting input terminal of the error amplifier 240. The error amplifier 240 generates an error signal V_{ERR} based on error between the comparison voltage V_{C} and the reference voltage V_{REF}, and outputs the error signal V_{ERR} from the output terminal of the error amplifier 240 itself. If the comparison voltage V_{C} is higher than the reference voltage V_{REF}, the error amplifier 240 increases the potential of the error signal V_{ERR}. If the comparison voltage V_{C} is lower than the reference voltage V_{REF}, the error amplifier 240 reduces the potential of the error signal V_{ERR}.

The circuit 250 performs switching control over the switching circuit 10 on the basis of the error signal V_{ERR} in such a manner as to reduce error between the comparison voltage V_{C} and the reference voltage V_{REF} (to converge the error to zero). The circuit 250 is connected to respective gates of the switching transistor 11 and the synchronous rectifier transistor 12 and controls a gate potential at each of the switching transistor 11 and the synchronous rectifier transistor 12, thereby controlling the state of each of the switching transistor 11 and the synchronous rectifier transistor 12. The circuit 250 makes the switching transistor 11 and the synchronous rectifier transistor 12 on and off alternately under the above-described switching control.

In the normally-connected state, “V_{FB}=V_{LD}=V_{POUT}−ΔV.” Here, the voltage source 220 is configured and the boost converter 1 is configured in such a manner as to establish “ΔV<V_{J}.” Thus, in the normally-connected state, “V_{POUT}−V_{J}<V_{FB}” is established and the signal S210 is set to the low level. It is assumed that the target voltage V_{TG} with respect to the load voltage V_{LD} is 4.8 V, the voltage ΔV is 0.1 V, and the judging voltage V_{J} is 0.8 V, for example. Then, in a situation where the load voltage V_{LD} is stabilized at the target voltage V_{TG} in the normally-connected state, the output terminal voltage V_{POUT} is 4.9 V, the feedback voltage V_{FB} is 4.8 V, and the voltage (V_{POUT}−V_{J}) is 4.1 V and thus the signal S210 is at the low level, as shown in FIG. 5. As a result, the switch element 231 is off in the normally-connected state, and the comparison voltage V_{C} is determined as a divided voltage of the feedback voltage V_{FB} divided by the voltage dividing circuit configured by the resistors R1 and R2. Specifically, in the normally-connected state, “V_{C}=V_{FB}·R2/(R1+R2)” is established. Here, it is assumed, for example, that the reference voltage V_{REF} is 1.2 V. In this case, by setting the resistance value of the resistor R1 three times the resistance value of the resistor R2, the target voltage V_{TG} with respect to the load voltage V_{LD} becomes 4.8 V in the normally-connected state.

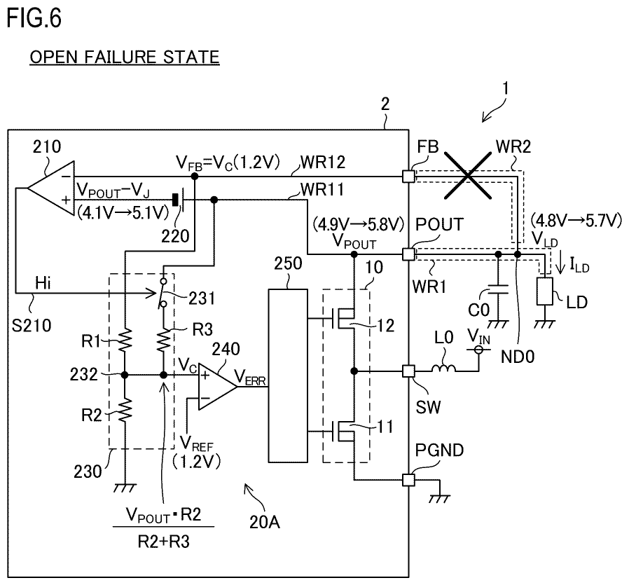

The feedback terminal FB is in the open state in the open failure state. Thus, as shown in FIG. 6, a voltage at the node 232 is transmitted to the feedback terminal FB so a voltage applied to the feedback terminal FB (feedback voltage V_{FB}) becomes equal to the comparison voltage V_{C}. On the assumption that a transition has suddenly been made from the normally-connected state in FIG. 5 to the open failure state while “V_{C}=V_{REF},” the comparison voltage V_{C} is 1.2 V that is lower than 4.1 V corresponding to the voltage (V_{POUT}−V_{J}) immediately after the transition. For this reason, “V_{POUT}−V_{J}>V_{FB}” is established and the signal S210 is set to the high level. This makes the switch element 231 on. As a result, the comparison voltage V_{C} is determined as a divided voltage of the output terminal voltage V_{POUT} divided by a voltage dividing circuit configured by the resistors R2 and R3 (specifically, “V_{C}=V_{POUT}·R2/(R2+R3)” is established).

Here, the resistance value of the resistor R3 is set larger than the resistance value of the resistor R1. Thus, the output terminal voltage V_{POUT} and the load voltage V_{LD} in the open failure state are higher than the output terminal voltage V_{POUT} and the load voltage V_{LD} in the normally-connected state. As a more specific example, the respective values of the resistors R2, R3 and the reference voltage V_{REF} are set in such a manner that the output terminal voltage V_{POUT} becomes 5.8 V if “V_{C}=V_{POUT}·R2/(R2+R3)=V_{REF}.” Thus, on the occurrence of the transition from the normally-connected state in FIG. 5 to the open failure state in FIG. 6, the switch element 231 becomes on, then the output terminal voltage V_{POUT} increases from 4.9 V to 5.8 V, and the output terminal voltage V_{POUT} is stabilized at 5.8 V. At this time, the load voltage V_{LD} is stabilized at 5.7 V (supposing that the voltage ΔV is fixed at 0.1 V).

While the description has been given on the assumption that the transition has suddenly been made from the normally-connected state in FIG. 5 to the open failure state for the sake of convenience, it also applies to a situation where the power supply IC 2 is started in the open failure state.

As described above, the comparison voltage generation circuit 230 generates the comparison voltage V_{C} using one of the feedback voltage V_{FB} and the output terminal voltage V_{POUT} interchangeably in response to a magnitude relationship between the voltage (V_{POUT}−V_{J}) lower than the output terminal voltage V_{POUT} by the predetermined judging voltage V_{J} and the feedback voltage V_{FB}. In the normally-connected state, “V_{POUT}−V_{J}<V_{FB}.” In this state, the comparison voltage V_{C} is generated on the basis of the feedback voltage V_{FB}. In the open failure state, “V_{POUT}−V_{J}>V_{FB}.” In this state, the comparison voltage V_{C} is generated on the basis of the output terminal voltage V_{POUT} and independently of the feedback voltage V_{FB}.

The circuit 250 may perform switching control using the PWM. Under the switching control using the PWM, the switching transistor 11 and the synchronous rectifier transistor 12 are made on and off alternately at a predetermined PWM frequency and an on-duty of the switching transistor 11 is adjusted on the basis of the error signal V_{ERR}. Under the switching control using the PWM, with the intention of reducing error between the comparison voltage V_{C} and the reference voltage V_{REF}, the circuit 250 reduces the on-duty of the switching transistor 11 in response to increase in the error signal V_{ERR} and increases the on-duty of the switching transistor 11 in response to reduction in the error signal V_{ERR}.

In another case, the circuit 250 may perform switching control using the PFM. Under the switching control using the PFM, the switching transistor 11 and the synchronous rectifier transistor 12 are made on and off alternately at a variable switching frequency and a switching frequency is adjusted on the basis of the error signal V_{ERR}. Under the switching control using the PFM, one on duration of the switching transistor 11 (the length of the on period) is constant. Under the switching control using the PFM, with the intention of reducing error between the comparison voltage V_{C} and the reference voltage V_{REF}, the circuit 250 reduces a switching frequency in response to increase in the error signal V_{ERR} and increases a switching frequency in response to reduction in the error signal V_{ERR}.

### Second Practical Example

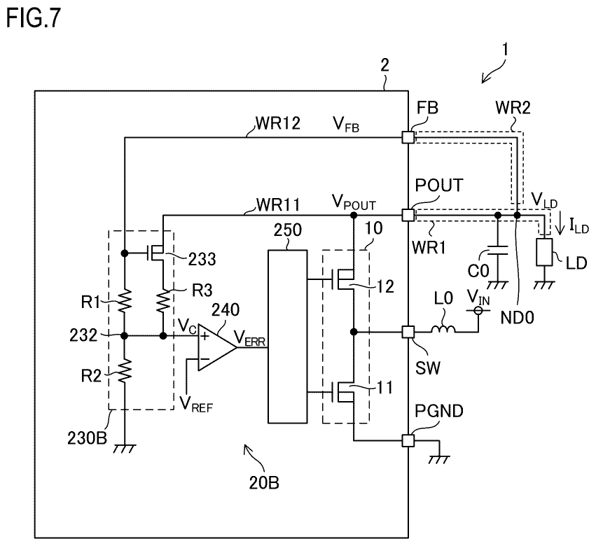

A second practical example will be described. FIG. 7 shows the configuration of a boost converter 1 according to the second practical example. The boost converter 1 according to the second practical example includes a control driving circuit 20B as the control driving circuit 20.

The control driving circuit 20B includes a comparison voltage generation circuit 230B, an error amplifier 240, and a circuit 250 with a logic circuit and a driving circuit. The driving circuit 20B does not require the comparator 210 and the voltage source 220 shown in FIG. 4. Specifically, on the basis of the control driving circuit 20A in FIG. 4, the control driving circuit 20B is obtained by deleting the comparator 210 and the voltage source 220 and replacing the comparison voltage generation circuit 230 in FIG. 4 with the comparison voltage generation circuit 230B. Except for these deletion and replacement, the control driving circuit 20B has the same configuration as the control driving circuit 20A.

The comparison voltage generation circuit 230B includes resistors R1 to R3 and a switch element 233, and generates a comparison voltage V_{C} on the basis of the feedback voltage V_{FB} and the output terminal voltage V_{POUT}. The resistors R1 to R3 are the same as those described in the first practical example. Thus, one end of the resistor R1 is connected to the feedback terminal FB via the internal wire WR12 and receives a voltage (namely, feedback voltage V_{FB}) applied to the feedback terminal FB. The other end of the resistor R1 is connected to a node 232. One end of the resistor R2 is connected to the node 232. The other end of the resistor R2 is connected to the ground. The resistor R1 and the resistor R2 form a voltage dividing circuit that divides the feedback voltage V_{FB}.

The switch element 233 is a P-channel MOSFET. In the following, the switch element 233 will be called a transistor. A source of the transistor 233 is connected to the output terminal POUT via the internal wire WR11 and receives the output terminal voltage V_{POUT}. A drain of the transistor 233 is connected to one end of the resistor R3. The other end of the resistor R3 is connected to the node 232. A gate of the transistor 233 is connected to the feedback terminal FB via the internal wire WR12 and receives the feedback voltage V_{FB}.

Like in the first practical example, the comparison voltage V_{C} is generated at the node 232. A gate threshold voltage for the transistor 233 is expressed as “V_{TH}.” The voltage V_{TH} represents the magnitude (absolute value) of the gate threshold voltage for the transistor 233 and is “V_{TH}>0” accordingly.

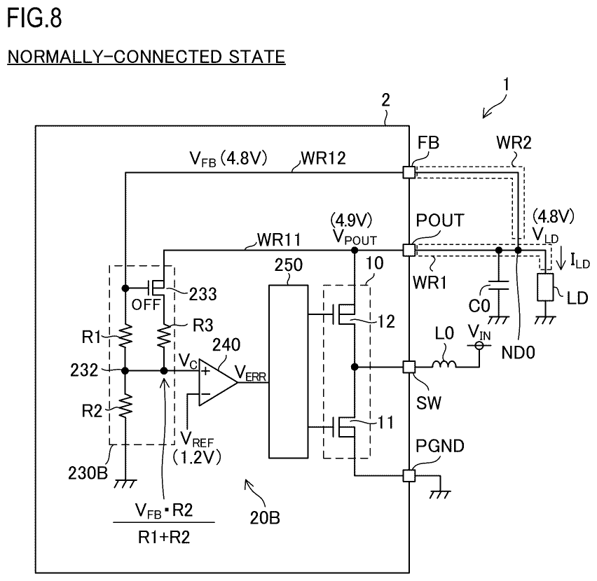

In the normally-connected state, “V_{FB}=V_{LD}=V_{POUT}−ΔV.” Here, the transistor 233 is configured and the boost converter 1 is configured in such a manner as to establish “ΔV<V_{TH}.” Thus, in the normally-connected state, “V_{POUT}−V_{TH}<V_{FB}” is established and the transistor 233 becomes off. It is assumed that the target voltage V_{TG} with respect to the load voltage V_{LD} is 4.8 V, the voltage ΔV is 0.1 V, and the gate threshold voltage V_{TH} is 0.8 V, for example. Then, in a situation where the load voltage V_{LD} is stabilized at the target voltage V_{TG} in the normally-connected state, the output terminal voltage V_{POUT} is 4.9 V and the feedback voltage V_{FB} is 4.8 V as shown in FIG. 8. This makes the magnitude of a gate-to-source voltage at the transistor 233 smaller than the gate threshold voltage V_{TH}, so that the transistor 233 becomes off. When the transistor 233 is off, the comparison voltage V_{C} is determined as a divided voltage of the feedback voltage V_{FB} divided by the voltage dividing circuit configured by the resistors R1 and R2 (specifically, “V_{C}=V_{FB}·R2/(R1+R2)” is established). Here, it is assumed, for example, that the reference voltage V_{REF} is 1.2 V. In this case, by setting the resistance value of the resistor R1 three times the resistance value of the resistor R2, the target voltage V_{TG} with respect to the load voltage V_{LD} becomes 4.8 V in the normally-connected state.

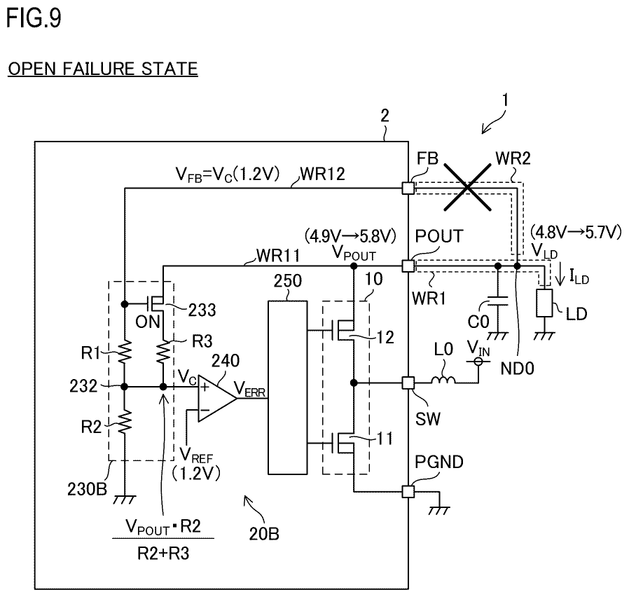

The feedback terminal FB is in the open state in the open failure state. Thus, as shown in FIG. 9, a voltage at the node 232 is transmitted to the feedback terminal FB so a voltage applied to the feedback terminal FB (feedback voltage V_{FB}) becomes equal to the comparison voltage V_{C}. On the assumption that a transition has suddenly been made from the normally-connected state in FIG. 8 to the open failure state while “V_{C}=V_{REF},” the comparison voltage V_{C} is 1.2 V that is lower than 4.1 V corresponding to the voltage (V_{POUT}−V_{TH}) immediately after the transition. This makes the transistor 233 on. As a result, the comparison voltage V_{C} is determined as a divided voltage of the output terminal voltage V_{POUT} divided by a voltage dividing circuit configured by the resistors R2 and R3 (specifically, “V_{C}=V_{POUT}·R2/(R2+R3)” is established).

Here, like in the first practical example, the resistance value of the resistor R3 is set larger than the resistance value of the resistor R1. Thus, the output terminal voltage V_{POUT} and the load voltage V_{LD} in the open failure state are higher than the output terminal voltage V_{POUT} and the load voltage V_{LD} in the normally-connected state. As a more specific example, the respective values of the resistors R2, R3 and the reference voltage V_{REF} are set in such a manner that the output terminal voltage V_{POUT} becomes 5.8 V if “V_{C}=V_{POUT}·R2/(R2+R3)=V_{REF}.” Thus, on the occurrence of the transition from the normally-connected state in FIG. 8 to the open failure state in FIG. 9, the transistor 233 becomes on, then the output terminal voltage V_{POUT} increases from 4.9 V to 5.8 V, and the output terminal voltage V_{POUT} is stabilized at 5.8 V. At this time, the load voltage V_{LD} is stabilized at 5.7 V (supposing that the voltage ΔV is fixed at 0.1 V).

While the description has been given on the assumption that the transition has suddenly been made from the normally-connected state in FIG. 8 to the open failure state for the sake of convenience, it also applies to a situation where the power supply IC 2 is started in the open failure state.

As described above, the comparison voltage generation circuit 230B generates the comparison voltage V_{C} using one of the feedback voltage V_{FB} and the output terminal voltage V_{POUT} interchangeably in response to a magnitude relationship between the voltage (V_{POUT}−V_{TH}) lower than the output terminal voltage V_{POUT} by the predetermined gate threshold voltage V_{TH} and the feedback voltage V_{FB}. In the normally-connected state, “V_{POUT}−V_{TH}<V_{FB}.” In this state, the comparison voltage V_{C} is generated on the basis of the feedback voltage V_{FB}. In the open failure state, “V_{POUT}−V_{TH}>V_{FB}.” In this state, the comparison voltage V_{C} is generated on the basis of the output terminal voltage V_{POUT} and independently of the feedback voltage V_{FB}. The operations of the error amplifier 240 and the circuit 250 are the same as those shown in the first practical example.

A PNP bipolar transistor may be used as the switch element 233. In this case, an emitter of the bipolar transistor may be connected to the output terminal POUT via the internal wire WR11, a collector of the bipolar transistor may be connected to the resistor R3 (connected to the node 232 via the resistor R3), and a base of the bipolar transistor may be connected to the feedback terminal FB via the internal wire WR12. At the PNP bipolar transistor as the switch element 233, if a base potential is lower than an emitter potential and if the magnitude of a base-to-emitter voltage is equal to or greater than a predetermined threshold voltage, the bipolar transistor is on. If not, the bipolar transistor is off. In the normally-connected state, the bipolar transistor as the switch element 233 is off. In the open failure state, the bipolar transistor as the switch element 233 is on.

### Third Practical Example

A third practical example will be described. In the third practical example, supplementary issues to the foregoing substances or modified techniques will be described.

A power supply monitoring circuit not shown in the drawings may be provided separately from the boost converter 1, and the output terminal voltage V_{POUT} or the load voltage V_{LD} may be monitored using the power supply monitoring circuit. Setting the resistance value of the resistor R3 larger than the resistance value of the resistor R1 allows the output terminal voltage V_{POUT} and the load voltage V_{LD} in the open failure state to be higher than those in the normally-connected state. By doing so, it becomes possible for the power supply monitoring circuit to judge whether abnormality (here, abnormality corresponding to the open failure state) has occurred at the boost converter 1. In another case, the resistance value of the resistor R3 can be set equal to the resistance value of the resistor R1.

In the foregoing description, it is assumed that the open failure state is a state where the feedback terminal FB and the node ND0 are insulated from each other via a sufficiently high insulating resistance. Meanwhile, in some cases, there is also a state where the feedback terminal FB and the node ND0 are connected to each other via a resistive component of about a few hundred kilohms, for example (this state will be called an intermediate state). In the intermediate state, the switch element 231 in FIG. 4 may be on or off depending on the resistive component between the feedback terminal FB and the node ND0. This state results in the state in FIG. 5 (or an approximate state) if the signal S210 in FIG. 4 is at the low level, and results in the state in FIG. 6 (or an approximate state) if the signal S210 in FIG. 4 is at the high level. Likewise, in the intermediate state, the transistor 233 in FIG. 7 may be on or off depending on the resistive component between the feedback terminal FB and the node ND0. This state results in the state in FIG. 8 (or an approximate state) if the transistor 233 is off, and results in the state in FIG. 9 (or an approximate state) if the transistor 233 is on.

While it has been assumed that a P-channel MOSFET is used as the rectifier element 12, an N-channel MOSFET may be used as the rectifier element 12. Alternatively, a rectifier diode may be used as the rectifier element 12. In this case, an anode and a cathode of the diode as the rectifier element 12 may be connected to the switch terminal SW and the output terminal POUT respectively.

Regarding an arbitrary signal or an arbitrary voltage, the high level and the low level thereof can be defined in an inverse relationship unless it impairs the purport given above.

A channel type of the FET (field-effect transistor) in each embodiment is shown as an example. A channel type of an arbitrary FET is changeable between a P-channel and an N-channel unless it impairs the purport given above.

The foregoing arbitrary transistor may be a transistor of an arbitrary type unless it causes inconvenience. For example, the foregoing arbitrary transistor described as an MOSFET is replaceable with a junction FET, an IGBT (insulated gate bipolar transistor), or a bipolar transistor, for example, unless it causes inconvenience. The arbitrary transistor has a first electrode, a second electrode, and a control electrode. In the FET, one of the first and second electrodes is a drain, the other is a source, and the control electrode is a gate. In the IGBT, one of the first and second electrodes is a collector, the other is an emitter, and the control electrode is a gate. In the bipolar transistor not categorized as an IGBT, one of the first and second electrodes is a collector, the other is an emitter, and the control electrode is a base.

The embodiment of the present disclosure can be modified in many ways, as appropriate, within a range of the technical concept defined in the claims. The embodiment described above is only an exemplary embodiment of the present disclosure, and what is meant by any of the terms used in the present disclosure and used in relation to each constituting element is not limited to that mentioned in connection with the foregoing embodiment. The specific numerical values mentioned in the above description are merely illustrative and are certainly changeable to various values.

### Appendices

The following provides appendices relating to the present disclosure having the exemplary specific configurations shown in the above embodiment.

A power semiconductor device according to one aspect of the present disclosure is a power semiconductor device (2) used in a boost converter (1) to boost an input voltage (V_{IN}) and having a configuration (first configuration) comprising: an output terminal (POUT); a switching circuit (10) including a switching transistor (11) and configured to generate an output terminal voltage (V_{POUT}) at the output terminal using an inductor (L0) that receives the input voltage, the output terminal voltage resulting from boosting of the input voltage; a feedback terminal (FB) to receive a monitoring subject voltage (V_{LD}) responsive to the output terminal voltage via an external wire (WR2) of the power semiconductor device; and a control driving circuit (20, 20A, 20B) configured to control the switching circuit on the basis of error between a comparison voltage (V_{C}) and a predetermined reference voltage (V_{REF}), the comparison voltage being determined on the basis of a feedback voltage (V_{FB}) applied to the feedback terminal and the output terminal voltage.

When the monitoring subject voltage is transmitted to the feedback terminal, the switching circuit can be controlled on the basis of the error between the comparison voltage based on the feedback voltage and the reference voltage. This allows the monitoring subject voltage to be stabilized at a target voltage based on the reference voltage. Transmission of the monitoring subject voltage to the feedback terminal might be interrupted due to a break in an external wire, for example. In response to this, the above configuration allows control over the switching circuit using the comparison voltage based on the output terminal voltage. Thus, even if transmission of the monitoring subject voltage to the feedback terminal is interrupted, it is still possible to reduce the occurrence of a situation (excessive voltage boost) that might damage a part.

The power semiconductor device according to the above first configuration may have a configuration (a second configuration) where the control driving circuit includes: a comparison voltage generation circuit (230, 230B) configured to generate the comparison voltage using one of the feedback voltage and the output terminal voltage interchangeably in response to a magnitude relationship between a voltage lower than the output terminal voltage by a predetermined voltage (V_{J}, V_{TH}) and the feedback voltage; and an error amplifier (240) configured to generate an error signal (V_{ERR}) representing the error between the comparison voltage and the reference voltage, and the switching circuit is controlled on the basis of the error signal.

Thus, in a situation where transmission of the monitoring subject voltage to the feedback terminal is interrupted, the comparison voltage can be generated on the basis of the output terminal voltage instead of the feedback voltage, making it possible to reduce the occurrence of a situation (excessive voltage boost) that might damage a part.

The power semiconductor device according to the above second configuration may have a configuration (a third configuration) where the comparison voltage generation circuit generates the comparison voltage on the basis of the feedback voltage if the feedback voltage is higher than the voltage lower than the output terminal voltage by the predetermined voltage, and the comparison voltage generation circuit generates the comparison voltage on the basis of the output terminal voltage if the feedback voltage is lower than the voltage lower than the output terminal voltage by the predetermined voltage.

Compared to a state where the monitoring subject voltage is transmitted properly to the feedback terminal, in a state where transmission of the monitoring subject voltage to the feedback terminal is interrupted, the feedback voltage is expected to be reduced. According to the third configuration, in the state where transmission of the monitoring subject voltage to the feedback terminal is interrupted, it is possible to generate the comparison voltage on the basis of the output terminal voltage instead of the feedback voltage. This makes it possible to reduce the occurrence of a situation (excessive voltage boost) that might damage a part.

The power semiconductor device according to the above third configuration (see FIGS. 4 to 6) may have a configuration (a fourth configuration) where the control driving circuit (20A) further includes a comparator (210) configured to compare the voltage lower than the output terminal voltage by the predetermined voltage and the feedback voltage, the error amplifier has a first input terminal configured to receive the comparison voltage and a second input terminal configured to receive the reference voltage, the comparison voltage generation circuit includes a first resistor (R1) provided between the feedback terminal and the first input terminal, a second resistor (R2) provided between the first input terminal and a ground, and a series circuit composed of a switch element (231) and a third resistor (R3) and provided between the output terminal and the first input terminal, the switch element is made off on the basis of an output signal from the comparator to apply a divided voltage as the comparison voltage to the first input terminal if the feedback voltage is higher than the voltage lower than the output terminal voltage by the predetermined voltage, the divided voltage being a divided voltage of the feedback voltage divided by the first resistor and the second resistor, and the switch element is made on the basis of the output signal from the comparator to apply a voltage based on the output terminal voltage as the comparison voltage to the first input terminal if the feedback voltage is lower than the voltage lower than the output terminal voltage by the predetermined voltage.

The power semiconductor device according to the above third configuration (see FIGS. 7 to 9) may have a configuration (a fifth configuration) where the error amplifier has a first input terminal configured to receive the comparison voltage and a second input terminal configured to receive the reference voltage, the comparison voltage generation circuit includes a first resistor (R1) provided between the feedback terminal and the first input terminal, a second resistor (R2) provided between the first input terminal and a ground, and a series circuit composed of a switch element (233) and a third resistor (R3) and provided between the output terminal and the first input terminal, the switch element is a transistor having a first electrode connected to the output terminal, a second electrode connected to the third resistor, and a control electrode connected to the feedback terminal, the switch element is made off to apply a divided voltage as the comparison voltage to the first input terminal if the feedback voltage is higher than the voltage lower than the output terminal voltage by the predetermined voltage, the divided voltage being a divided voltage of the feedback voltage divided by the first resistor and the second resistor, and the switch element is made on to apply a voltage based on the output terminal voltage as the comparison voltage to the first input terminal if the feedback voltage is lower than the voltage lower than the output terminal voltage by the predetermined voltage.

The power semiconductor device according to any of the above second to fifth configurations may have a configuration (a sixth configuration) where the control driving circuit controls the switching circuit on the basis of the error signal in such a manner as to reduce the error between the comparison voltage and the reference voltage, and the output terminal voltage is higher in a second state where the comparison voltage is generated on the basis of the output terminal voltage than in a first state where the comparison voltage is generated on the basis of the feedback voltage.

As a result, it becomes possible for a power supply monitoring circuit that can be provided externally to the power semiconductor device to determine whether the state of the boost converter is the first state or the second state.

The power semiconductor device according to any of the above first to sixth configurations may have a configuration (a seventh configuration) where the control driving circuit controls the switching circuit using a voltage based on the feedback voltage as the comparison voltage if the monitoring subject voltage is applied as the feedback voltage to the feedback terminal via the external wire, and the control driving circuit controls the switching circuit using a voltage based on the output terminal voltage as the comparison voltage if transmission of the monitoring subject voltage to the feedback terminal is interrupted.

As a result, in a state where transmission of the monitoring subject voltage to the feedback terminal is interrupted, it becomes possible to control the switching circuit using the comparison voltage based on the output terminal voltage instead of using the comparison voltage based on the feedback voltage, thereby allowing reduction in the occurrence of a situation (excessive voltage boost) that might damage a part.

The power semiconductor device according to any of the above first to seventh configurations may have a configuration (an eighth configuration) where the power semiconductor device further comprises a switch terminal (SW) and a ground terminal (PGND), the switching transistor is provided between the switch terminal and the ground terminal, the inductor is provided between an application terminal for the input voltage and the switch terminal, and the switching circuit includes a rectifier element (12) provided between the switch terminal and the output terminal.

A boost converter according to one aspect of the present disclosure has a configuration (a ninth configuration) comprising: the power semiconductor device according to any of the above first to eighth configurations; the inductor (L0); and an output capacitor (C0) connected to the output terminal.

What is claimed is:

1. A power semiconductor device used in a boost converter to boost an input voltage, comprising:
an output terminal;
a switching circuit including a switching transistor and configured to generate an output terminal voltage at the output terminal using an inductor that receives the input voltage, the output terminal voltage resulting from boosting of the input voltage;
a feedback terminal to receive a monitoring subject voltage responsive to the output terminal voltage via an external wire of the power semiconductor device; and
a control driving circuit configured to control the switching circuit on the basis of error between a comparison voltage and a predetermined reference voltage, the comparison voltage being determined on the basis of a feedback voltage applied to the feedback terminal and the output terminal voltage.

2. The power semiconductor device according to claim 1, wherein
the control driving circuit includes:
a comparison voltage generation circuit configured to generate the comparison voltage using one of the feedback voltage and the output terminal voltage interchangeably in response to a magnitude relationship between a voltage lower than the output terminal voltage by a predetermined voltage and the feedback voltage; and
an error amplifier configured to generate an error signal representing the error between the comparison voltage and the reference voltage, and
the switching circuit is controlled on the basis of the error signal.

3. The power semiconductor device according to claim 2, wherein
the comparison voltage generation circuit generates the comparison voltage on the basis of the feedback voltage if the feedback voltage is higher than the voltage lower than the output terminal voltage by the predetermined voltage, and
the comparison voltage generation circuit generates the comparison voltage on the basis of the output terminal voltage if the feedback voltage is lower than the voltage lower than the output terminal voltage by the predetermined voltage.

4. The power semiconductor device according to claim 3, wherein
the control driving circuit further includes a comparator configured to compare the voltage lower than the output terminal voltage by the predetermined voltage and the feedback voltage,
the error amplifier has a first input terminal configured to receive the comparison voltage and a second input terminal configured to receive the reference voltage, the comparison voltage generation circuit includes a first resistor provided between the feedback terminal and the first input terminal, a second resistor provided between the first input terminal and a ground, and a series circuit composed of a switch element and a third resistor and provided between the output terminal and the first input terminal,
the switch element is made off on the basis of an output signal from the comparator to apply a divided voltage as the comparison voltage to the first input terminal if the feedback voltage is higher than the voltage lower than the output terminal voltage by the predetermined voltage, the divided voltage being a divided voltage of the feedback voltage divided by the first resistor and the second resistor, and
the switch element is made on the basis of the output signal from the comparator to apply a voltage based on the output terminal voltage as the comparison voltage to the first input terminal if the feedback voltage is lower than the voltage lower than the output terminal voltage by the predetermined voltage.

5. The power semiconductor device according to claim 3, wherein
the error amplifier has a first input terminal configured to receive the comparison voltage and a second input terminal configured to receive the reference voltage,
the comparison voltage generation circuit includes a first resistor provided between the feedback terminal and the first input terminal, a second resistor provided between the first input terminal and a ground, and a series circuit composed of a switch element and a third resistor and provided between the output terminal and the first input terminal,
the switch element is a transistor having a first electrode connected to the output terminal, a second electrode connected to the third resistor, and a control electrode connected to the feedback terminal,
the switch element is made off to apply a divided voltage as the comparison voltage to the first input terminal if the feedback voltage is higher than the voltage lower than the output terminal voltage by the predetermined voltage, the divided voltage being a divided voltage of the feedback voltage divided by the first resistor and the second resistor, and
the switch element is made on to apply a voltage based on the output terminal voltage as the comparison voltage to the first input terminal if the feedback voltage is lower than the voltage lower than the output terminal voltage by the predetermined voltage.

6. The power semiconductor device according to claim 2, wherein
the control driving circuit controls the switching circuit on the basis of the error signal in such a manner as to reduce the error between the comparison voltage and the reference voltage, and
the output terminal voltage is higher in a second state where the comparison voltage is generated on the basis of the output terminal voltage than in a first state where the comparison voltage is generated on the basis of the feedback voltage.

7. The power semiconductor device according to claim 1, wherein
the control driving circuit controls the switching circuit using a voltage based on the feedback voltage as the comparison voltage if the monitoring subject voltage is applied as the feedback voltage to the feedback terminal via the external wire, and
the control driving circuit controls the switching circuit using a voltage based on the output terminal voltage as the comparison voltage if transmission of the monitoring subject voltage to the feedback terminal is interrupted.

8. The power semiconductor device according to claim 1, further comprising:
a switch terminal and a ground terminal, wherein
the switching transistor is provided between the switch terminal and the ground terminal,
the inductor is provided between an application terminal for the input voltage and the switch terminal, and
the switching circuit includes a rectifier element provided between the switch terminal and the output terminal.

9. A boost converter comprising:
the power semiconductor device according to claim 1;
the inductor; and
an output capacitor connected to the output terminal.
